(19) United States
(12) Patent Application Publication
(10) Pub. No.: US 2025/0053133 A1
(43) Pub. Date: Feb. 13, 2025

(54) IMAGE FORMING APPARATUS AND METHOD OF COMPONENT REPLACEMENT FOR IMAGE FORMING APPARATUS

(71) Applicant: FUJIFILM Business Innovation Corp., Tokyo (JP)

(72) Inventors: Kazuki KISHI, Kanagawa (JP); Yutaka KIUCHI, Kanagawa (JP)

(73) Assignee: FUJIFILM Business Innovation Corp., Tokyo (JP)

(21) Appl. No.: 18/434,306

(22) Filed: Feb. 6, 2024

(30) Foreign Application Priority Data
Aug. 10, 2023 (JP) 2023-131599

(51) Int. Cl. G03G 21/16

(52) U.S. Cl. CPC G03G 21/1647

(57) ABSTRACT

An image forming apparatus includes: first and second drum members that extend in one direction and have a cylindrical shape; first and second sheet members that are replaceably wound around outer peripheries of the first and second drum members, respectively, in a state where one end and the other end of each of the first and second sheet members are separated from each other in a circumferential direction, the first and second sheet members coming in contact with a medium on which an image is to be formed; and an angular displacement mechanism that angularly displaces the first and second drum members in tandem to switch among a first attachment position where the one end of the first sheet member is attached to the first drum member in a state where the first sheet member is removed, a second attachment position where the second sheet member is attached to the second drum member in a state where the second sheet member is removed, and a third attachment position where the other end of the first sheet member that is attached during the first attachment position is attached to the first drum member, in an order of the first attachment position, the second attachment position, and the third attachment position.

### CROSS-REFERENCE TO RELATED APPLICATIONS

This application is based on and claims priority under 35 USC 119 from Japanese Patent Application No. 2023-131599 filed Aug. 10, 2023.

### BACKGROUND

### (i) Technical Field

The present disclosure relates to an image forming apparatus and a method of component replacement for the image forming apparatus.

### (ii) Related Art

Japanese Unexamined Patent Application Publication No. 58-005769 discloses an image forming apparatus including a transfer device that transfers an image on an image carrier onto a transfer material. The transfer device includes transport means that moves the transfer material along a circulating movement path, and a gripper piece that is attached to the transport means, is supported by a rotary shaft, rotates with respect to a base member, and grips a leading end side of the transfer material.

### SUMMARY

Aspects of non-limiting embodiments of the present disclosure relate to reducing the time required for attachment work as compared with a configuration in which a position is switched to a position where one end and the other end of a first sheet member is attached to a first drum member, and then is switched to a position where a second sheet member is attached to a second drum member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: first and second drum members that extend in one direction and have a cylindrical shape; first and second sheet members that are replaceably wound around outer peripheries of the first and second drum members, respectively, in a state where one end and another end of each of the first and second sheet members are separated from each other in a circumferential direction, the first and second sheet members coming in contact with a medium on which an image is to be formed; and an angular displacement mechanism that angularly displaces the first and second drum members in tandem to switch among a first attachment position where the one end of the first sheet member is attached to the first drum member in a state where the first sheet member is removed, a second attachment position where the second sheet member is attached to the second drum member in a state where the second sheet member is removed, and a third attachment position where the another end of the first sheet member that is attached during the first attachment position is attached to the first drum member, in an order of the first attachment position, the second attachment position, and the third attachment position.

### BRIEF DESCRIPTION OF THE DRAWINGS

An exemplary embodiment of the present disclosure will be described in detail based on the following figures, wherein:

FIG. 1 is a schematic front view illustrating a configuration of an image forming apparatus according to an exemplary embodiment of the present disclosure;

FIG. 2 is a top perspective view illustrating a periphery of a counter roller included in the image forming apparatus according to the exemplary embodiment of the present disclosure;

FIG. 3 is a front view of the counter roller included in the image forming apparatus according to the exemplary embodiment of the present disclosure;

FIG. 4 is a front view of a transfer jacket included in the image forming apparatus according to the exemplary embodiment of the present disclosure;

FIG. 5 is a top perspective view illustrating a periphery of a chain transport device and a fixing roller included in the image forming apparatus according to the exemplary embodiment of the present disclosure;

FIG. 6 is a front view of a fixing device included in the image forming apparatus according to the exemplary embodiment of the present disclosure;

FIG. 7 is a front view of a fixing jacket included in the image forming apparatus according to the exemplary embodiment of the present disclosure;

FIG. 8 is a front view illustrating a first position in the image forming apparatus according to the exemplary embodiment of the present disclosure;

FIG. 9 is a front view illustrating a third position in the image forming apparatus according to the exemplary embodiment of the present disclosure;

FIG. 10 is a front view illustrating a fourth position in the image forming apparatus according to the exemplary embodiment of the present disclosure; and

FIG. 11 is a front view illustrating a fifth position in the image forming apparatus according to the exemplary embodiment of the present disclosure.

### DETAILED DESCRIPTION

### (Configuration of Exemplary Embodiment)

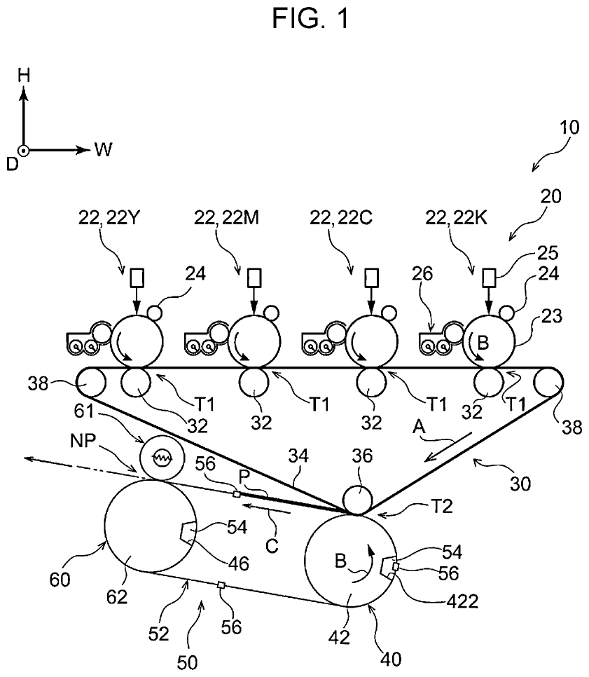

An example of an image forming apparatus according to an exemplary embodiment of the present disclosure will be described with reference to FIGS. 1 to 11. Note that, in the drawings, arrow H indicates an up-down direction (vertical direction) of the apparatus, arrow W indicates a width direction (horizontal direction) of the apparatus, and arrow D indicates a depth direction (horizontal direction) of the apparatus.

### (Image Forming Apparatus 10)

FIG. 1 is a schematic front view illustrating a configuration of an image forming apparatus 10 according to an exemplary embodiment of the present disclosure. The image forming apparatus 10 according to the present exemplary embodiment is an electrophotographic image forming apparatus that forms a toner image on a sheet P. The sheet P is an example of a medium on which an image is to be formed. The image forming apparatus 10 includes an image forming section 20, a chain transport device 50, a fixing device (a fixing roller 60 and a heating roller 61), and a controller not illustrated.

### (Image Forming Section 20)

The image forming section 20 includes a toner image forming section 22 that forms a toner image and a transfer device 30 that transfers the toner image formed in the toner image forming section 22 onto a sheet P.

Furthermore, a plurality of the toner image forming sections 22 are provided so as to form a toner image for each color. The image forming apparatus 10 includes toner image forming sections 22 (22Y, 22M, 22C, 22K) of a total of four colors, yellow (Y), magenta (M), cyan (C), and black (K). In the following description, in a case where Y, M, C, and K are not particularly distinguished from each other, Y, M, C, and K may be omitted in some cases.

The toner image forming sections 22 of the respective colors are basically configured to have common specifications except for toners to be used. Specifically, the toner image forming section 22 of each color includes a photoconductor drum 23 that rotates in a predetermined direction (direction of arrow B), and a charger 24 that charges the photoconductor drum. Furthermore, the toner image forming section 22 of each color includes an exposure device 25 that forms an electrostatic latent image on the photoconductor drum by exposing the photoconductor drum charged by the charger, and a developing device 26 that develops the electrostatic latent image formed on the photoconductor drum by the exposure device using toner.

The transfer device 30 includes first transfer rollers 32, a transfer belt 34, a second transfer roller 36, and a counter roller 40.

The first transfer roller 32 transfers the toner image formed on the photoconductor drum 23 onto the transfer belt 34 at T1 located between the photoconductor drum 23 and the first transfer roller 32.

The transfer belt 34 has an endless shape and is wound around a plurality of rollers 38, whereby the posture thereof is determined. When at least one of the plurality of rollers 38 is rotationally driven, the transfer belt 34 rotationally moves in a direction of arrow A and transports the firstly transferred image.

At least a portion of the transfer belt 34 is wound around the second transfer roller 36. The counter roller 40 is disposed so as to face the second transfer roller 36 with the transfer belt 34 interposed therebetween. With such a configuration, the second transfer roller 36 rotates in the direction of arrow B along with the rotationally moving transfer belt 34. A sheet P supplied from an upstream side is transported while being sandwiched between the counter roller 40 and the transfer belt 34, and the transfer belt 34 transfers the toner image on the sheet P at a transfer position T2 (second transfer).

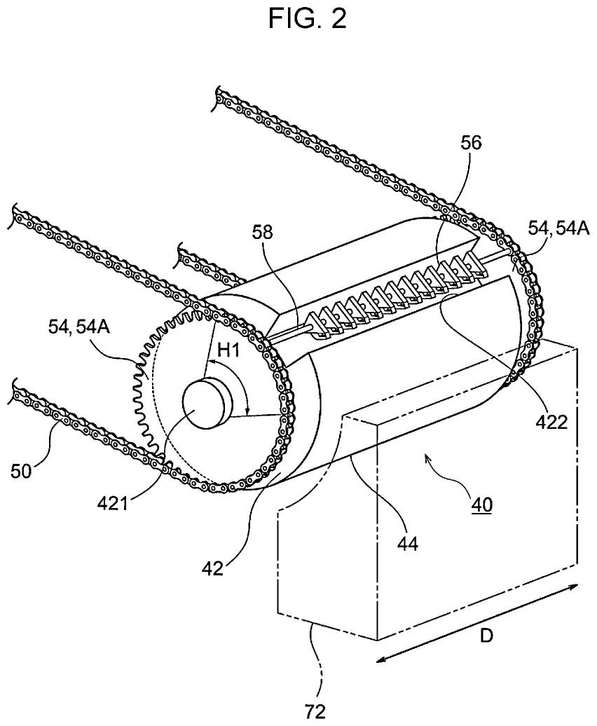

The counter roller 40 includes a transfer drum 42 and a transfer jacket 44. The transfer drum 42 and the transfer jacket 44 are examples of a first drum member and a first sheet member, respectively. FIG. 2 is a top perspective view illustrating a periphery of the counter roller 40 included in the image forming apparatus 10 according to the exemplary embodiment of the present disclosure.

The transfer drum 42 has a cylindrical shape extending in the depth direction, fixes the transfer jacket 44 on an outer periphery thereof, and is supported by sprockets 54A of the chain transport device 50 described later. The transfer drum 42 is angularly displaced by the chain transport device 50 about a shaft portion 421 provided at the center. Angular displacement is also referred to as rotation or inching. The transfer drum 42 includes a recess 422.

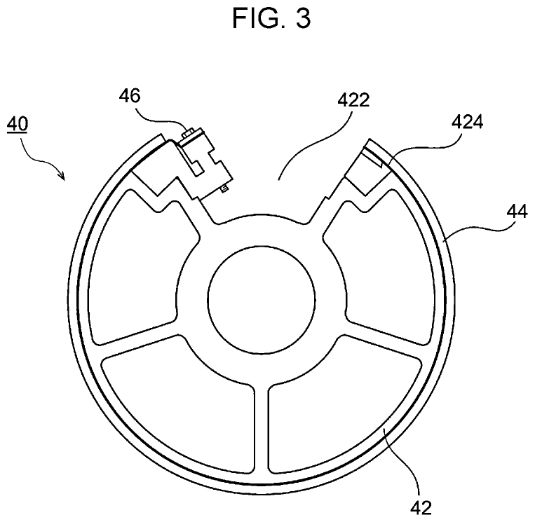

FIG. 3 is a front view of the counter roller 40 included in the image forming apparatus 10 according to the exemplary embodiment of the present disclosure. The recess 422 extends in the depth direction, forms a groove shape opening in the radial direction in an outer peripheral surface of the transfer drum 42, and spans from one end in a circumferential direction of the transfer drum 42 (right side in the drawing) to the other end (left side). The recess 422 accommodates grippers 56 of the chain transport device 50, described later, at a predetermined timing. The recess 422 is an example of a notch. Furthermore, the recess 422 includes a step portion 424. The step portion 424 extends in the depth direction and is recessed inward on one end side in a circumferential direction of the recess 422. The step portion 424 includes a surface facing radially outward and a surface facing the other end side of the recess 422 in the circumferential direction. In the step portion 424, the surface facing the other end side of the recess 422 in the circumferential direction is an inclined surface inclined such that the outer peripheral side of the transfer drum 42 protrudes toward the other end side of the recess 422 compared to the inner peripheral side. With such a configuration, a claw 442, described later, is accommodated in the step portion 424, and engages with the inclined surface. In other words, the step portion 424 can hold the claw 442 described later. Note that the step portion 424 is an example of a holding member.

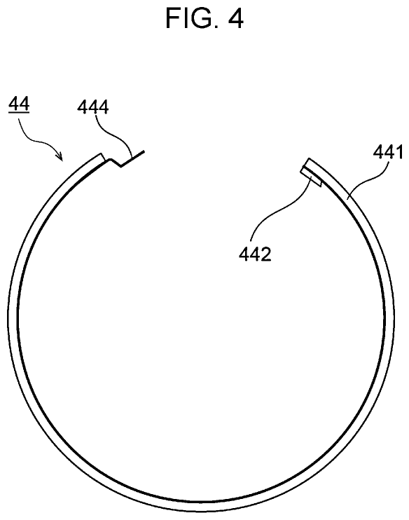

FIG. 4 is a front view of the transfer jacket 44 included in the image forming apparatus 10 according to the exemplary embodiment of the present disclosure. The transfer jacket 44 is a sheet-shaped and layer-shaped member extending in the depth direction, is replaceably wound around the outer periphery of the transfer drum 42, and comes in contact with a sheet P on its outer periphery. One end of the transfer jacket 44 is fixed to the one end side in the circumferential direction of the recess 422, and the other end of the transfer jacket 44 is fixed to the other end side in the circumferential direction of the recess 422 via a fixing member 46. That is, the transfer jacket 44 is wound around the transfer drum 42 in a state where the one end and the other end of the transfer jacket 44 are separated from each other in the circumferential direction with the recess 422 interposed therebetween. The transfer jacket 44 includes a base layer 444, a surface layer 441, and the claw 442.

The surface layer 441 is a sheet-shaped member extending in the depth direction, forms an outer portion of the transfer jacket 44, and comes in contact with the sheet P through an outer peripheral surface of the surface layer 441 and the second transfer roller 36.

The base layer 444 is a sheet-shaped member extending in the depth direction, and forms an inner portion of the transfer jacket 44 to be non-adhesively wound around the transfer drum, ensuring the winding strength of the transfer jacket 44. The surface layer 441 is adhesively fixed to an outer peripheral surface of the base layer 444, and the claw 442 is fixed to a portion of an inner peripheral surface of the base layer 444. The portion forms the one end of the transfer jacket 44. The base layer 444 is longer in length than the surface layer 441 in the circumferential direction in a state of being wound around the transfer drum 42, and has a portion forming the other end of the transfer jacket 44 in a state in which the portion protrudes from the surface layer 441. The base layer 444 serving as the other end of the transfer jacket 44 is fixed to the transfer drum 42 via the fixing member 46.

The claw 442 includes one end having a tapered shape corresponding to the inclined surface of the step portion 424 and the other end having a flat shape corresponding to an inner surface of the recess 422 in a front view (as viewed in the axial direction of the transfer drum 42), and is formed to extend in the depth direction as a whole. The claw 442 has a function of engaging the transfer jacket 44 with the step portion 424 of the transfer drum 42. When the one end of the claw 442 is engaged with the step portion 424 of the transfer drum 42, the transfer jacket 44 is temporarily held on the transfer drum 42. That is, the step portion 424 of the transfer drum 42 temporarily holds the transfer jacket 44 via the claw 442. Note that the temporary holding refers to a state in which the claw 442 is engaged with the step portion 424 and the transfer jacket 44 is fastened by a fixing member (not illustrated) at a predetermined position with a torque less than a predetermined torque.

### (Chain Transport Device 50)

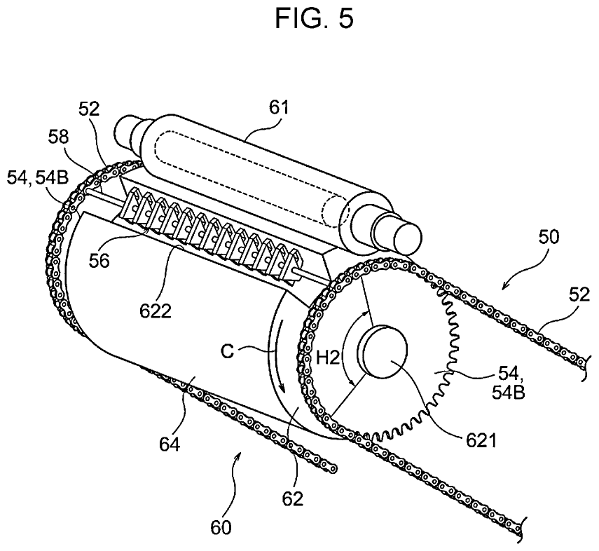

FIG. 5 is a top perspective view illustrating a periphery of the chain transport device 50 and the fixing roller 60 included in the image forming apparatus according to the exemplary embodiment of the present disclosure. The chain transport device 50 is an example of an angular displacement mechanism. The chain transport device 50 includes a pair of chains 52, a pair of sprockets 54, the grippers 56, and an attachment member 58. As illustrated in FIG. 1, the chain transport device 50 transports a sheet P from the transfer position T2, where transfer is performed by the counter roller 40, to a fixing position NP, where fixing is performed by the fixing roller 60 described later. The chain transport device 50 synchronizes the counter roller 40 and the fixing roller 60, described later, and angularly displaces both the counter roller 40 and the fixing roller 60 by having the pair of chains 52 mesh with the pair of sprockets 54. On the other hand, during a maintenance position described later, the chain transport device 50 sequentially switches the positions of both the counter roller 40 and the fixing roller 60, described later, by angularly displacing the counter roller 40 and the fixing roller 60 in tandem on the basis of a control signal from the controller.

The pair of chains 52 have an endless shape and are disposed so as to be separated from each other in the depth direction of the apparatus. The pair of chains 52 are wound around at least a pair of the sprockets 54A and a pair of sprockets 54B, whereby the posture thereof is determined. As illustrated in FIG. 2, the pair of sprockets 54A are disposed on one end side and the other end side in the axial direction of the counter roller 40, with the axial direction oriented in the depth direction. As illustrated in FIG. 5, the pair of sprockets 54B are disposed on one end side and the other end side in the axial direction of the fixing roller 60 described later. When either the pair of sprockets, 54A or 54B, rotates, the chains 52 rotationally moves in a direction of arrow C.

Furthermore, the grippers 56 that grip a sheet P are attached to the pair of chains 52 via the attachment member 58.

A plurality of the grippers 56 are provided and attached to the attachment member 58 at predetermined intervals along the depth direction. The gripper 56 is an example of a gripping portion. The gripper 56 includes a plurality of pinching portions (not illustrated) that can be separated from and come into contact with each other. With such a configuration, the grippers 56 grip a leading edge of the sheet P by pinching the leading edge of the sheet P between the pinching portions (not illustrated).

As illustrated in FIG. 2, when a sheet P passes between the transfer belt 34 and the counter roller 40, the grippers 56 are accommodated in the recess 422 formed in the transfer drum 42.

### (Fixing Device)

The fixing device includes the fixing roller 60 and the heating roller 61. As illustrated in FIG. 5, the fixing roller 60 is disposed on a side opposite to the heating roller 61 with a sheet P (not illustrated) interposed therebetween, so as to come in contact with a surface of the sheet P facing downward and extend in the depth direction with the axial direction oriented in the depth direction. As illustrated in FIG. 1, the fixing roller 60 fixes a toner image to the sheet P at the fixing position NP together with the heating roller 61. The fixing roller 60 includes a fixing drum 62 and a fixing jacket 64. The fixing drum 62 and the fixing jacket 64 are examples of a second drum member and a second sheet member, respectively.

In FIG. 5, the fixing drum 62 has a cylindrical shape extending in the depth direction, fixes the fixing jacket 64 on an outer periphery thereof, and is supported by the pair of sprockets 54B of the chain transport device 50. The fixing drum 62 is angularly displaced by the chain transport device 50 about a shaft portion 621 provided at the center. The fixing drum 62 includes a recess 622.

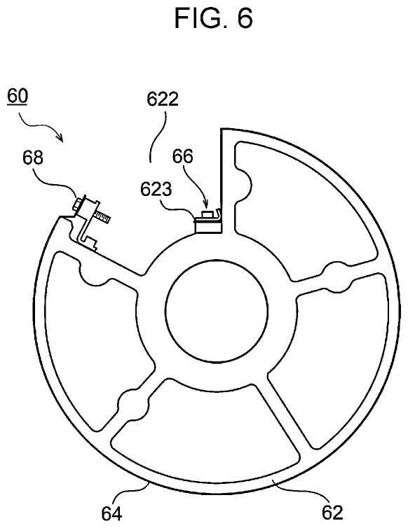

FIG. 6 is a front view of the fixing roller 60 included in the image forming apparatus 10 according to the exemplary embodiment of the present disclosure. The recess 622 extends in the depth direction, forms a groove shape opening in the radial direction in an outer peripheral surface of the fixing drum 62, and spans from one end in a circumferential direction of the fixing drum 62 (right side in the drawing) to the other end (left side in the drawing). The recess 622 accommodates the grippers 56 of the chain transport device 50 at a predetermined timing. The recess 622 is an example of a notch. Furthermore, the recess 622 includes a bottom portion 623. The bottom portion 623 is a bottom surface that extends in the depth direction, is formed on one end side of the recess 622, and is located in the radial direction of the fixing drum from the outer peripheral surface side of the recess 622. The bottom portion 623 is an example of a bottom surface.

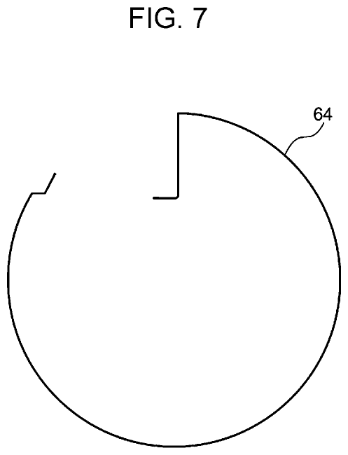

FIG. 7 is a front view of the fixing jacket 64 included in the image forming apparatus 10 according to the exemplary embodiment of the present disclosure. The fixing jacket 64 is a sheet-shaped member extending in the depth direction, is replaceably wound around the outer periphery of the fixing drum 62, and comes in contact with a sheet P on its outer periphery.

The fixing jacket 64 has an arc shape and is wound around the outer periphery of the fixing drum 62. One end of the fixing jacket 64 extends toward the center of the arc, is bent in an L shape, and is fixed to the bottom portion 623 of the recess 622 of the fixing drum 62 via a fixing member 66 in a state of facing the bottom portion 623. The other end of the fixing jacket 64 is bent inward of the arc, extends toward the one end side, and is fixed to the other end side of the recess 622 of the fixing drum 62 via a fixing member 68. That is, the fixing jacket 64 is wound around the fixing drum 62 in a state where the one end and the other end of the fixing jacket 64 are separated from each other in the circumferential direction with the recess 622 of the fixing drum 62 interposed therebetween and tension is applied to the fixing jacket 64.

### (Drawer)

A drawer (not illustrated) is a frame-shaped body, and is provided inside a housing forming the image forming apparatus 10. The drawer (not illustrated) accommodates the counter roller 40, the chain transport device 50, the fixing device (the fixing roller 60 and the heating roller 61), and a peripheral member 72 (see FIG. 2), which are parts of the image forming apparatus 10. When the drawer is pulled out from the housing, the counter roller 40, the chain transport device 50, the fixing device, and the peripheral member 72 are moved to the outside of the housing in which the image forming section 20 excluding the counter roller 40 is left. In the image forming apparatus 10, a state in which the drawer is pulled out is considered a state in which maintenance or replacement is performed for elements moved to the outside of the housing (a state in which the drawer is located at a maintenance position described later).

### (Replacement of Transfer Jacket and Fixing Jacket)

In the image forming apparatus 10 according to the present exemplary embodiment, the transfer jacket 44, the fixing jacket 64, and the grippers 56 are replaced at predetermined timings. Replacement refers to actions that include both removal and attachment.

In the replacement work of the transfer jacket 44, the fixing jacket 64, and the grippers 56, the drawer (not illustrated) is pulled out from the inside toward the outside of the image forming apparatus 10, toward the front side in the depth direction (see FIG. 1) to the maintenance position by an operator. The maintenance position is a position of the drawer (not illustrated) pulled out to the maximum.

All the positions from a first position to a fifth position are stored in the controller in advance. During the maintenance position, each time an operator presses the operation button, a control signal is transmitted to the chain transport device 50, and the position of the transfer drum 42 and the fixing drum 62 is switched to the first position, the second position, the third position, the fourth position, and the fifth position in this order.

The chain transport device 50 angularly displaces the transfer drum 42 and the fixing drum 62 in tandem to switch among the first position, the second position, the third position, the fourth position, and the fifth position, in the order of the first position, the second position, the third position, the fourth position, and the fifth position. Furthermore, the angular displacement of the transfer drum 42 from the first position to the fifth position by the chain transport device 50 is performed within a range equal to or less than 360°. The first position, the second position, the third position, the fourth position, and the fifth position are examples of a first removal position, a gripping portion removal position, a first attachment position, a second attachment position, and a third attachment position, respectively.

### (First Position)

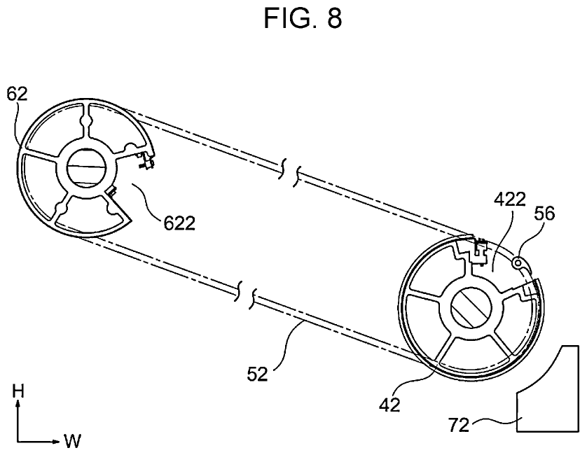

FIG. 8 is a front view illustrating the first position in the image forming apparatus 10 according to the exemplary embodiment of the present disclosure. When an operator presses the operation button in a state where the transfer jacket 44 is fixed to the transfer drum 42, the chain transport device 50 angularly displaces the transfer drum 42 and the fixing drum 62 counterclockwise on the basis of a control signal to switch the position of the transfer drum 42 and the fixing drum 62 to the first position. The counterclockwise direction is an example of one direction. During the first position, the transfer jacket 44 is removed from the transfer drum 42. That is, during the first position, a first step is performed in which the transfer jacket 44 that comes in contact with a sheet P on which an image is to be formed is detached from the outer periphery of the transfer drum 42.

During the first position, the chain transport device 50 exposes the recess 422 of the transfer drum 42 upward in the up-down direction (see FIG. 2). In the transfer drum 42, the exposure refers to angularly displacing a portion to be worked in the transfer drum 42 to fall within a range H1 where an operator can access the portion to be worked. Furthermore, the accessible range H1 refers to a range within which the pair of chains 52 are wound around the pair of sprockets 54A and the peripheral member 72 is not provided. During the first position in FIG. 8, both the one end and the other end of the recess 422 of the transfer drum 42 fall within the range of H1. During the first position, a fixing member (not illustrated) and the fixing member 46 are removed by an operator, thereafter the transfer jacket 44 is removed from the transfer drum 42. Note that, during the first position, the one end and the other end of the recess 622 of the fixing drum 62 are located at a non-exposed position described later, so that the fixing jacket 64 cannot be removed from the fixing drum 62.

### (Second Position)

Next, when an operator presses the operation button, the chain transport device 50 angularly displaces the transfer drum 42 and the fixing drum 62 counterclockwise on the basis of a control signal to switch the position of the transfer drum 42 and the fixing drum 62 from the first position to the second position. During the second position, both the grippers 56 and the attachment member 58 fall within the range of H1 and are exposed, and the one end and the other end of the recess 622 of the fixing drum 62 are located at the non-exposed position, so that the fixing jacket 64 cannot be removed from the fixing drum 62. During the second position, the grippers 56 and the attachment member 58 are removed from the recess 422 of the transfer drum 42 in a state where the transfer jacket 44 is removed. Note that the second position is assumed to be a position different from the first position, but the first position and the second position may be the same position. In this case, the chain transport device 50 does not angularly displaces the transfer drum 42 and the fixing drum 62. Furthermore, the second position may be the same position as the third position described later.

### (Third Position)

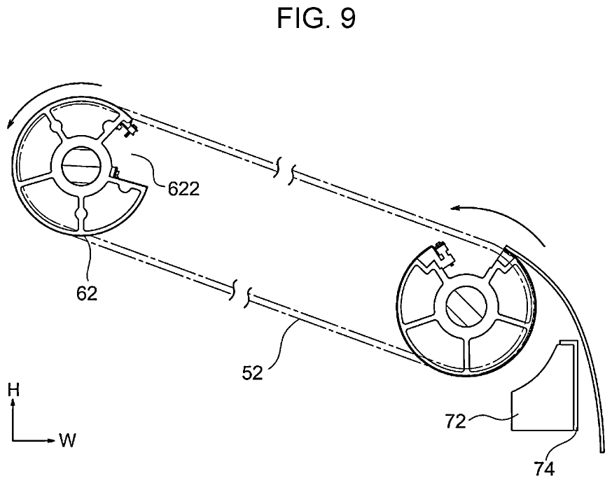

FIG. 9 is a front view illustrating the third position in the image forming apparatus 10 according to the exemplary embodiment of the present disclosure. When an operator presses the operation button, the chain transport device 50 angularly displaces the transfer drum 42 and the fixing drum 62 counterclockwise on the basis of a control signal to switch the position of the transfer drum 42 and the fixing drum 62 from the second position to the third position, exposing the step portion 424 of the transfer drum 42. During the third position, the step portion 424 of the transfer drum 42 falls within the range of H1, and the step portion 424 faces directly upward in the up-down direction (12 o'clock position on a clock). During the third position, the claw 442 at the one end of another transfer jacket 44 is temporarily held on the step portion 424 of the transfer drum 42 in a state where the transfer jacket 44 is removed. That is, during the third position, after the first step, a second step is performed in which the one end of another transfer jacket 44 is attached to the transfer drum 42 that is angularly displaced counterclockwise. Note that, during the third position, the one end and the other end of the recess 622 of the fixing drum 62 are located at the non-exposed position, so that the fixing jacket 64 cannot be removed from the fixing drum 62.

Furthermore, during the third position, a cover 74 is installed, by an operator, on one side of the peripheral member 72 and on a side opposite to the transfer drum 42 with the peripheral member 72 interposed therebetween. The cover 74 is a sheet-shaped buffer material, and covers at least a range in which one surface of the temporarily held transfer jacket 44 comes in contact with the peripheral member 72. By providing the cover 74 on the peripheral member 72, even if the temporarily held transfer jacket 44 hangs down, the one surface of the transfer jacket 44 is protected.

### (Fourth Position)

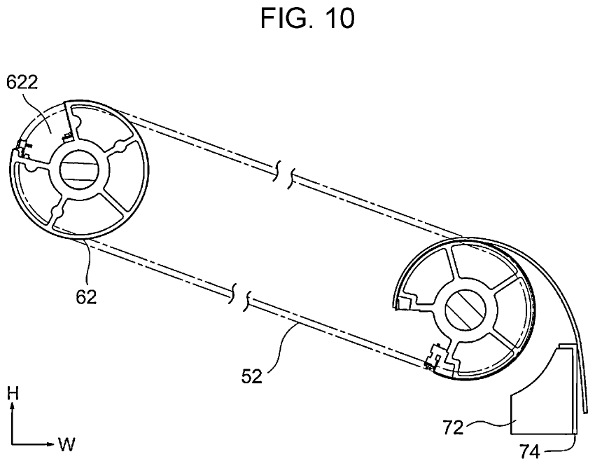

FIG. 10 is a front view illustrating the fourth position in the image forming apparatus 10 according to the exemplary embodiment of the present disclosure. When an operator presses the operation button, the chain transport device 50 angularly displaces the transfer drum 42 and the fixing drum 62 counterclockwise on the basis of a control signal to switch the position of the transfer drum 42 and the fixing drum 62 from the third position to the fourth position, exposing the recess 622 of the fixing drum 62. In the fixing drum 62, the exposure refers to angularly displacing a portion to be worked in the fixing drum 62 to fall within a range H2 where an operator can access the portion to be worked. Furthermore, the accessible range H2 refers to a range within which the chains 52 are wound around the sprockets 54B and the heating roller 61 is not provided. During the fourth position in FIG. 10, both the one end and the other end of the recess 622 of the fixing drum 62 fall within the range of H2, so that the recess 622 is exposed. During the fourth position, the fixing member 66 and the fixing member 68 are removed by an operator.

Next, after the fixing jacket 64 is removed from the fixing drum 62 by the operator, another fixing jacket 64 is attached to the fixing drum 62 in a state where the fixing jacket 64 is removed, thus replacing the fixing jacket 64 on the fixing drum 62. That is, during the fourth position, after the second step, a third step is performed in which the fixing jacket 64 is removed from the outer periphery of the fixing drum 62 that is angularly displaced in tandem with the transfer drum 42 that is angularly displaced counterclockwise, and another fixing jacket 64 is attached to the outer periphery of the fixing drum 62. Note that, during the fourth position, the one end and the other end of the recess 422 of the transfer drum 42 are located at a non-exposed position, so that the transfer jacket 44 is in a state of temporarily held on the transfer drum 42 and is not fixed.

### (Fifth Position)

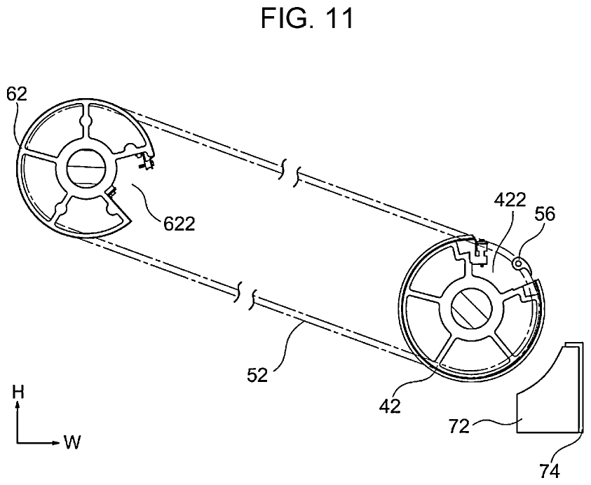

FIG. 11 is a front view illustrating the fifth position in the image forming apparatus 10 according to the exemplary embodiment of the present disclosure. When an operator presses the operation button, the chain transport device 50 angularly displaces the transfer drum 42 and the fixing drum 62 counterclockwise on the basis of a control signal to switch the position of the transfer drum 42 and the fixing drum 62 from the fourth position to the fifth position. During the fifth position, at least the other end of the recess 422 of the transfer drum 42 is exposed. In FIG. 11, the fifth position is assumed to be the same as the first position. During the fifth position, the other end of the another transfer jacket 44 attached during the third position is fixed to the transfer drum 42 by an operator. When the another transfer jacket 44 is fixed to the transfer drum 42, the replacement of the transfer jacket is completed. That is, during the fifth position, after the third step, a fourth step is performed in which the other end of the another transfer jacket 44 in the second step is attached to the transfer drum 42 that is angularly displaced counterclockwise.

### Operations and Effects

Next, operations and effects of the present exemplary embodiment will be described.

In the image forming apparatus 10 or the method of component replacement for the image forming apparatus 10, the chain transport device 50 angularly displaces the transfer drum 42 and the fixing drum 62 in tandem in a state where the transfer jacket 44 is temporarily held on the transfer drum 42 in a state where the transfer jacket 44 is removed. Next, the fixing jacket 64 is replaced on the fixing drum 62. Then, after the replacement of the fixing jacket 64, the transfer jacket 44 is fixed to the transfer drum 42.

The image forming apparatus 10 according to the exemplary embodiment of the present disclosure includes the transfer drum 42 and the fixing drum 62, the transfer jacket 44 and the fixing jacket 64, and the chain transport device 50. The transfer drum 42 and the fixing drum 62 extend in one direction and have a cylindrical shape. The transfer jacket 44 and the fixing jacket 64 are replaceably wound around the outer peripheries of the transfer drum 42 and the fixing drum 62, respectively, in a state where one end and the other end of each of the transfer jacket 44 and the fixing jacket 64 are separated from each other in the circumferential direction. The transfer jacket 44 and the fixing jacket 64 come in contact with the sheet P on which an image is to be formed. The chain transport device 50 angularly displaces the transfer drum 42 and the fixing drum 62 in tandem to switch among the third position where the one end of the transfer jacket 44 is attached to the transfer drum 42 in a state where the transfer jacket 44 is removed, the fourth position where the fixing jacket 64 is attached to the fixing drum 62 in a state where the fixing jacket 64 is removed, and the fifth position where the other end of the transfer jacket 44 that is attached during the third position is attached to the transfer drum 42, in order of the third position, the fourth position, and the fifth position.

Furthermore, a method of component replacement for the image forming apparatus 10 according to the exemplary embodiment of the present disclosure includes the first step, the second step, the third step, and the fourth step. In the first step, the transfer jacket 44, which comes in contact with the sheet P on which an image is to be formed, is removed from the outer periphery of the transfer drum 42. In the second step, one end of another transfer jacket 44 is attached to the transfer drum 42 that is angularly displaced in one direction after the first step. In the third step, after the second step, the fixing jacket 64 is removed from the outer periphery of the fixing drum 62 that is angularly displaced in tandem with the transfer drum 42 that is angularly displaced in the one direction, and another fixing jacket 64 is attached to the outer periphery of the fixing drum 62. In the fourth step, after the third step, the other end of the another transfer jacket 44 in the second step is attached to the transfer drum 42 that is angularly displaced in the one direction. The angular displacement of the transfer drum 42 from the first step to the fourth step is performed within a range equal to or less than 360°.

In the image forming apparatus 10 according to the exemplary embodiment of the present disclosure, the time required for the attachment work can be reduced as compared with a configuration in which the position is switched to the position where the one end and the other end of the transfer jacket 44 is attached to the transfer drum 42, and then is switched to the position where the fixing jacket 64 is attached to the fixing drum 62. Furthermore, in the method of component replacement for the image forming apparatus 10 according to the exemplary embodiment of the present disclosure, the time required for the attachment work can be reduced as compared with a method in which the position is switched to the position where the one end and the other end of the transfer jacket 44 is attached to the transfer drum 42, and then is switched to the position where the fixing jacket 64 is attached to the fixing drum 62.

Furthermore, in the image forming apparatus 10 according to the exemplary embodiment of the present disclosure, the transfer drum 42 includes the recess 422 that extend in the one direction and is formed between the one end and the other end of the transfer jacket 44. The one end and the other end of the transfer jacket 44 are separated from each other in the circumferential direction with the recess 422 interposed therebetween. Before the third position, the chain transport device 50 switches the position of the transfer drum 42 and the fixing drum 62 to the first position where the transfer jacket 44 is removed from the transfer drum 42, and exposes the recess 422 of the transfer drum 42 during the first position. Accordingly, the chain transport device 50 exposes the one end and the other end of the recess 422 of the transfer drum 42 during the first position, and the one end and the other end of the transfer jacket 44 are removed during the first position.

In the image forming apparatus 10 according to the exemplary embodiment of the present disclosure, the transfer jacket 44 includes the claw 442 on the one end. The transfer drum 42 includes the step portion 424 that is configured to hold the claw 442 of the transfer jacket 44 on the recess 422. The chain transport device 50 exposes the step portion 424 of the transfer drum 42 during the third position. The transfer drum 42 temporarily holds the transfer jacket 44.

In the image forming apparatus 10 according to the exemplary embodiment of the present disclosure, the fixing drum 62 includes the recess 622 that extend in the one direction and is formed between the one end and the other end of the fixing jacket 64. The chain transport device 50 exposes the recess 622 of the fixing drum 62 during the fourth position. Accordingly, the one end and the other end of the recess 622 of the fixing drum 62 are exposed, and the fixing jacket 64 is replaced during the fourth position.

In the image forming apparatus 10 according to the exemplary embodiment of the present disclosure, the recess 622 of the fixing drum 62 includes the bottom portion 623 to which the one end of the fixing jacket 64 is attached. The bottom portion 623 is located in the radial direction of the fixing drum 62. This ensures a wide range within which an image is to be formed as compared with a configuration in which the one end of the fixing jacket 64 is attached to the outer peripheral surface of the fixing jacket 64.

In the image forming apparatus 10 according to the exemplary embodiment of the present disclosure, the chain transport device 50 includes the grippers 56 that grip the sheet P. Before the third position, the chain transport device 50 switches the position of the transfer drum 42 and the fixing drum 62 to the first position where the transfer jacket 44 is removed from the transfer drum 42, and between the first position and the third position, switches the position of the transfer drum 42 and the fixing drum 62 to the second position where the grippers 56 are removed from the chain transport device 50. The time required for the replacement work of the transfer jacket 44, the fixing jacket 64, and the grippers 56 can be reduced as compared with a configuration in which the grippers 56 are replaced after the position is switched from the third position to the fourth position.

### MODIFIED EXAMPLES

The present disclosure has been described in detail with respect to a specific exemplary embodiment, but the present disclosure is not limited to the exemplary embodiment, and it is apparent to those skilled in the art that the present disclosure can adopt various other exemplary embodiments within the scope of the present disclosure.

With regard to the replacement order of the jackets, the transfer jacket 44 may be replaced on the transfer drum 42 in a state where one end of the fixing jacket 64 is temporarily held on the fixing drum 62 from which the fixing jacket 64 is removed, and then the other end of the fixing jacket 64 may be fixed to the fixing drum 62.

When the transfer jacket 44 is removed from the transfer drum 42 in a case where there is a cleaner (not illustrated) that is disposed along the transfer drum 42 and removes the toner adhering to the transfer drum 42, the transfer jacket 44 may be removed in a state where the cleaner is retracted in a direction away from the transfer drum 42.

With regard to the attachment of the cover 74 to the peripheral member 72, the cover 74 may always be attached to the peripheral member 72, or temporarily be attached to the peripheral member 72.

With regard to the replacement of the grippers 56, only the transfer jacket 44 and the fixing jacket 64 may be replaced and the grippers 56 may not be replaced.

The drawer is assumed to be pulled out to the maintenance position by an operator, but the present disclosure is not limited thereto. The drawer may be automatically moved to the maintenance position on the basis of a control signal from the controller. Furthermore, the angular displacement of the transfer drum 42 and the fixing drum 62 is assumed to be performed on the basis of a control signal when an operator presses the operation button, but the present disclosure is not limited thereto. For example, a maintenance mode in which elements are automatically replaced may be provided, and the transfer drum 42 and the fixing drum 62 may be automatically angularly displaced on the basis of a shift instruction to the maintenance mode from the controller.

With regard to the positions at which the transfer drum 42 and the fixing drum 62 are stopped, the transfer drum 42 and the fixing drum 62 may be provided with engraved marks or other indications corresponding to the respective positions, and the transfer drum 42 and the fixing drum 62 may be angularly displaced by an operator in accordance with the indications for some or all of the steps.

The direction in which the transfer drum 42 and the fixing drum 62 are angularly displaced is assumed to be counterclockwise in the exemplary embodiment, but the direction may be clockwise as long as the direction is a fixed direction during the replacement work.

### APPENDIX

(((1)))

An image forming apparatus comprising:
first and second drum members that extend in one direction and have a cylindrical shape;
first and second sheet members that are replaceably wound around outer peripheries of the first and second drum members, respectively, in a state where one end and another end of each of the first and second sheet members are separated from each other in a circumferential direction, the first and second sheet members coming in contact with a medium on which an image is to be formed; and an angular displacement mechanism that angularly displaces the first and second drum members in tandem to switch among a first attachment position where the one end of the first sheet member is attached to the first drum member in a state where the first sheet member is removed, a second attachment position where the second sheet member is attached to the second drum member in a state where the second sheet member is removed, and a third attachment position where the another end of the first sheet member that is attached during the first attachment position is attached to the first drum member, in an order of the first attachment position, the second attachment position, and the third attachment position.

(((2)))

The image forming apparatus according to (((1))), wherein
the first drum member includes a notch that extends in the one direction and is formed between the one end and the another end of the first sheet member,
the one end and the another end of the first sheet member are separated from each other in a circumferential direction with the notch interposed between the one end and the another end, and
the angular displacement mechanism is configured to:
before the first attachment position, switch a position of the first and second drum members to a first removal position where the first sheet member is removed from the first drum member; and
expose the notch of the first drum member during the first removal position.

(((3)))

The image forming apparatus according to (((2))), wherein
the first sheet member includes a claw on the one end,
the first drum member includes a holding member configured to hold the claw of the first sheet member on the notch, and
the angular displacement mechanism is configured to expose the holding member of the first drum member during the first attachment position.

(((4)))

The image forming apparatus according to any one of (((1))) to (((3))), wherein
the second drum member includes a notch that extends in the one direction and is formed between the one end and the another end of the second sheet member, and
the angular displacement mechanism is configured to expose the notch of the second drum member during the second attachment position.

(((5)))

The image forming apparatus according to (((4))), wherein the notch of the second drum member includes a bottom surface to which the one end of the second sheet member is attached, the bottom surface being located in a radial direction of the second drum member.

(((6)))

The image forming apparatus according to any one of (((1))) to (((5))), wherein
the angular displacement mechanism:

includes a gripping portion that grips the medium, and
is configured to, before the first attachment position, switch a position of the first and second drum members to a first removal position where the first sheet member is removed from the first drum member, and between the first removal position and the first attachment position, switch the position of the first and second drum members to a gripping portion removal position where the gripping portion is removed from the angular displacement mechanism.

(((7)))

A method of component replacement for an image forming apparatus, comprising:
a first step of removing a first sheet member from an outer periphery of a first drum member, the first sheet member coming in contact with a medium on which an image is to be formed;
a second step of attaching one end of another first sheet member to the first drum member that is angularly displaced in one direction after the first step;
a third step of removing, after the second step, a second sheet member from an outer periphery of a second drum member that is angularly displaced in tandem with the first drum member that is angularly displaced in the one direction and of attaching another second sheet member to the outer periphery of the second drum member; and
a fourth step of attaching, after the third step, another end of the another first sheet member in the second step to the first drum member that is angularly displaced in the one direction, wherein
angular displacement of the first drum member from the first step to the fourth step is performed within a range equal to or less than 360°.

What is claimed is:

1. An image forming apparatus comprising:
first and second drum members that extend in one direction and have a cylindrical shape;
first and second sheet members that are replaceably wound around outer peripheries of the first and second drum members, respectively, in a state where one end and another end of each of the first and second sheet members are separated from each other in a circumferential direction, the first and second sheet members coming in contact with a medium on which an image is to be formed; and
an angular displacement mechanism that angularly displaces the first and second drum members in tandem to switch among a first attachment position where the one end of the first sheet member is attached to the first drum member in a state where the first sheet member is removed, a second attachment position where the second sheet member is attached to the second drum member in a state where the second sheet member is removed, and a third attachment position where the another end of the first sheet member that is attached during the first attachment position is attached to the first drum member, in an order of the first attachment position, the second attachment position, and the third attachment position.

2. The image forming apparatus according to claim 1, wherein
the first drum member includes a notch that extends in the one direction and is formed between the one end and the another end of the first sheet member,
the one end and the another end of the first sheet member are separated from each other in a circumferential direction with the notch interposed between the one end and the another end, and
the angular displacement mechanism is configured to:
before the first attachment position, switch a position of the first and second drum members to a first removal position where the first sheet member is removed from the first drum member; and
expose the notch of the first drum member during the first removal position.

3. The image forming apparatus according to claim 2, wherein
the first sheet member includes a claw on the one end,
the first drum member includes a holding member configured to hold the claw of the first sheet member on the notch, and
the angular displacement mechanism is configured to expose the holding member of the first drum member during the first attachment position.

4. The image forming apparatus according to claim 1, wherein
the second drum member includes a notch that extends in the one direction and is formed between the one end and the another end of the second sheet member, and
the angular displacement mechanism is configured to expose the notch of the second drum member during the second attachment position.

5. The image forming apparatus according to claim 4, wherein the notch of the second drum member includes a bottom surface to which the one end of the second sheet member is attached, the bottom surface being located in a radial direction of the second drum member.

6. The image forming apparatus according to claim 1, wherein
the angular displacement mechanism includes a gripping portion that grips the medium, and
the angular displacement mechanism is configured to, before the first attachment position, switch a position of the first and second drum members to a first removal position where the first sheet member is removed from the first drum member, and between the first removal position and the first attachment position, switch the position of the first and second drum members to a gripping portion removal position where the gripping portion is removed from the angular displacement mechanism.

7. A method of component replacement for an image forming apparatus, comprising:
a first step of removing a first sheet member from an outer periphery of a first drum member, the first sheet member coming in contact with a medium on which an image is to be formed;
a second step of attaching one end of another first sheet member to the first drum member that is angularly displaced in one direction after the first step;
a third step of removing, after the second step, a second sheet member from an outer periphery of a second drum member that is angularly displaced in tandem with the first drum member that is angularly displaced in the one direction and of attaching another second sheet member to the outer periphery of the second drum member; and
a fourth step of attaching, after the third step, another end of the another first sheet member in the second step to the first drum member that is angularly displaced in the one direction, wherein
angular displacement of the first drum member from the first step to the fourth step is performed within a range equal to or less than 360°.
